(19) United States
(12) Patent Application Publication
(10) Pub. No.: US 2015/0277423 A1
(43) Pub. Date: Oct. 1, 2015

(54) METHOD AND APPARATUS FOR CONTROLLING A MACHINE TOOL

(71) Applicant: Okuma Corporation, Niwa-Gun (JP)

(72) Inventors: Yasunori KONDO, Niwa-Gun (JP); Tetsuya MATSUSHITA, Niwa-Gun (JP)

(21) Appl. No.: 14/629,863

(22) Filed: Feb. 24, 2015

(30) Foreign Application Priority Data
Mar. 27, 2014 (JP) 2014-066509

(51) Int. Cl. G05B 19/402

(52) U.S. Cl. CPC G05B 19/402; G05B 2219/49185

(57) ABSTRACT

A method for controlling a machine tool in which a main spindle and a table are moved relative to each other by two or more translation axes and at least one rotation axis is provided. In the method, an error in a position of the tool with respect to the workpiece due to an error of the machine tool is corrected to calculate a translation axis command value and a rotation axis command value. The method includes a step of selecting an arbitrary axis configuration, a step of calculating a correction value for the translation axis for correcting the position error in a command value coordinate system of the translation axis included in the arbitrary axis configuration, and a step of calculating a correction value for the rotation axis for correcting the position error in a command value coordinate system of the rotation axis included in the arbitrary axis configuration.

The disclosure of Japanese Patent Application No. 2014-066509 filed on Mar. 27, 2014 including the specification, drawings and abstract is incorporated herein by reference in its entirety.

### BACKGROUND OF THE INVENTION

1. Field of the Invention

The present invention relates to methods and apparatuses for controlling a machine tool in which a main spindle on which a tool is mounted and a table that holds a workpiece are moved relative to each other by two or more translation axes and at least one rotation axis to machine the workpiece with the tool, and at least one of the main spindle and the table is provided in plural number, wherein an error in the position of the tool with respect to the workpiece due to an error of the machine tool is corrected to calculate a translation axis command value for controlling the translation axis and a rotation axis command value for controlling the rotation axis.

2. Description of Related Art

An example of such a machine tool is shown in FIG. 7. FIG. 7 is a schematic view of a 5-axis control machining center 101 having three translation axes and two rotation axes. A spindle head 102 has two translational degrees of freedom relative to a bed 103 by X- and Z-axes serving as translation axes perpendicular to each other. A table 104 has a single rotational degree of freedom relative to a cradle 105 by a C-axis serving as a rotation axis. The cradle 105 has a single rotational degree of freedom relative to a trunnion 106 by an A-axis serving as a rotation axis. The A-axis and the C-axis are perpendicular to each other. The trunnion 106 has a single translational degree of freedom relative to the bed 103 by a Y-axis serving as a translation axis perpendicular to the X- and Z-axes. Each axis is driven by a servomotor (not shown) that is controlled by a numerical control apparatus (not shown). A workpiece is fixed to the table 104, a tool (not shown) is mounted on the spindle head 102 and rotated. The workpiece is thus machined while the relative positions of the workpiece and the tool is controlled.

For example, factors that affect motion accuracy of the 5-axis control machining center 101 include geometric errors between the axes such as an error in the center position of the rotation axis (shift from its intended position) and an error in inclination of the rotation axis (squareness or parallelism between the axes). As such a geometric error decreases motion accuracy of the 5-axis control machining center 101 and decreases machining accuracy of workpieces, it is required to reduce the geometric error by adjustment. However, it is difficult to eliminate the geometric error by adjustment, and control of correcting the geometric error is performed to obtain accurate machining.

Japanese Patent Application Publication No. 2004-272887 (JP 2004-272887 A) proposes a method wherein as a way to correct a geometric error. In the method described in JP 2004-272887 A, the position of the distal end point of a tool is converted to the position of each translation axis in view of a geometric error of a machine tool, and these positions of the translation axes are used as command values for controlling the translation axes to correct a position error of the distal end point of the tool due to the geometric error.

Further, Japanese Patent Application Publication No. 2009-104317 (JP 2009-104317 A) describes a method for calculating command values for controlling translation axes. In this method, a deformation error associated with operation of a machine tool, a positioning error that is caused according to a command position for the translation axis, and an error that is caused by thermal displacement due to heat generation etc. of each element of the machine tool are regarded as a geometric error. Correction values for the translation axes calculated based on the geometric error are added to command values for the translation axes. The command values for controlling the translation axes are thus calculated.

Japanese Patent Application Publication No. 2009-172716 (JP 2009-172716 A) describes a method for correcting a machining error due to thermal deformation of a machine tool. The machine tool includes right and left headstocks facing each other on the same axis, a left tool rest that can be moved by a translation axis and that is used together with the left headstock to machine a workpiece in a left machining area, a right tool rest that can be moved by a translation axis and that is used together with the right headstock to machine the workpiece in a right machining area, and an upper tool rest that can be moved by a translation axis and a rotation axis and that is used to machine the workpiece in both the right and left machining areas. In this method, correction values in the directions of the translation axes and in the rotation direction of the rotation axis are computed for each machining area as values for correcting a machining error due to thermal deformation of the machine tool. The right and left tool rests and the upper tool rest are controlled based on command values for the translation axes and the rotation axis which have been corrected by the correction values.

However, the methods described in JP 2004-272887 A and JP 2009-104317 A are intended for machine tools including a single main spindle to which a tool for machining a workpiece is mounted and a single table that holds the workpiece. Accordingly, these methods have disadvantages when applied to machine tools in which at least one of the main spindle and the table is provided in plural number, and the main spindle or main spindles and the table or tables are moved relative to each other by two or more translation axes and at least one rotation axis. Specifically, a command value for each translation axis cannot be calculated by correcting an error of the machine tool such as a geometrical error, or a command value for each rotation axis cannot be calculated by correcting the error.

In the method described in JP 2009-172716 A, a machining error due to thermal displacement of a machine tool including a plurality of tool rests (the right and left tool rests and the upper tool rest) each having a main spindle, a plurality of headstocks (the right and left headstocks) each corresponding to a table can be corrected to calculate a command value for each translation axis that allows the corresponding tool rest to move, and a command value for the rotation axis that allows the main spindle of the upper tool rest to rotate. However, this method cannot satisfy the need to calculate command values for translation and rotation axes for an arbitrary axis configuration having an arbitrary translation axis included in a plurality of translation axes and a rotation axis, namely, the need to arbitrary calculate a command value for the translation axis by correcting an error of a machine tool and to calculate a command value for the rotation axis by correcting an error of the machine tool for the arbitrary axis configuration.

### SUMMARY OF THE INVENTION

It is an object of the present invention to provide a method and apparatus for controlling a machine tool which calculates, for an arbitrary axis configuration having an arbitrary translation axis and an arbitrary rotation axis, a command value for the translation axis and a command value for the rotation axis by correcting an error of the machine tool which includes a main spindle and a table and in which at least one of the main spindle and the table is provided in plural number.

A method for controlling a machine tool according to a first aspect of the present invention is a method for controlling a machine tool in which a main spindle on which a tool is mounted and a table that holds a workpiece are moved relative to each other by two or more translation axes and at least one rotation axis to machine the workpiece with the tool, and at least one of the main spindle and the table is provided in plural number. In the method, an error in a position of the tool with respect to the workpiece due to an error of the machine tool is calculated from a position of the tool in presence of the error of the machine tool, which is obtained by a homogeneous coordinate transformation from a tool coordinate system to a workpiece coordinate system with consideration of the error of the machine tool, and an ideal position of the tool, which is obtained by the homogeneous coordinate transformation from the tool coordinate system to the workpiece coordinate system without consideration of the error of the machine tool. Then, the error in the position of the tool is corrected to calculate a translation axis command value for controlling the translation axis and a rotation axis command value for controlling the rotation axis. The method includes a selection step, a translation axis correction value calculation step, a rotation axis correction value calculation step, and an update step. The selection step is a step of selecting an arbitrary axis configuration having an arbitrary translation axis included in the two or more translation axes and an arbitrary rotation axis included in the at least one rotation axis. The translation axis correction value calculation step is a step of calculating a correction value for the translation axis for correcting the error in the position of the tool in a command value coordinate system of the translation axis, based on a homogeneous coordinate transformation of the error in the position of the tool from the workpiece coordinate system to the command value coordinate system of the translation axis included in the arbitrary axis configuration selected in the selection step. The rotation axis correction value calculation step is a step of calculating a correction value for the rotation axis for correcting the error in the position of the tool in a command value coordinate system of the rotation axis, based on the error of the machine tool in a rotation direction of the rotation axis included in the arbitrary axis configuration selected in the selection step. The update step is a step of updating the translation axis command value by adding the correction value calculated in the translation axis correction value calculation step to the translation axis command value, and updating the rotation axis command value by adding the correction value calculated in the rotation axis correction value calculation step to the rotation axis command value.

According to a second aspect of the present invention, in the first aspect, the error of the machine tool is regarded as a geometric error. The error in the position of the tool is calculated from the position of the tool in presence of the geometric error, which is obtained by the homogeneous coordinate transformation from the tool coordinate system to the workpiece coordinate system with consideration of the geometric error, and the ideal position of the tool, which is obtained by the homogeneous coordinate transformation from the tool coordinate system to the workpiece coordinate system without consideration of the geometric error. In the translation axis correction value calculation step, the correction value for the translation axis for correcting the error in the position of the tool in the command value coordinate system of the translation axis is calculated based on the homogeneous coordinate transformation of the error in the position of the tool from the workpiece coordinate system to the command value coordinate system of the translation axis included in the arbitrary axis configuration selected in the selection step. In the rotation axis correction value calculation step, the correction value for the rotation axis for correcting the error in the position of the tool in the command value coordinate system of the rotation axis is calculated based on the geometric error in the rotation direction of the rotation axis included in the arbitrary axis configuration selected in the selection step.

According to a third aspect of the present invention, in the second aspect, the arbitrary translation axis is the translation axis to be actually used to machine the workpiece, and the arbitrary rotation axis is the rotation axis to be actually used to machine the workpiece. In the selection step, it is determined, based on used axis configuration determination information for determining a used axis configuration having the translation axis to be actually used to machine the workpiece and the rotation axis to be actually used to machine the workpiece, whether or not there is the used axis configuration in axis configurations which have the translation axis included in the two or more translation axes and the rotation axis included in the at least one rotation axis, In the selection step, then the determined used axis configuration is selected as the arbitrary axis configuration. In the translation axis correction value calculation step, the correction value for the translation axis is calculated based on the homogeneous coordinate transformation of the error in the position of the tool from the workpiece coordinate system to the command value coordinate system of the translation axis included in the used axis configuration selected in the selection step. In the rotation axis correction value calculation step, the correction value for the rotation axis is calculated based on the geometric error in the rotation direction of the rotation axis included in the used axis configuration selected in the selection step.

According to a fourth aspect of the present invention, in the third aspect, the method further includes an error decision step of deciding that the error in the position of the tool is to retain a previous error or to be set to zero if it is determined in the selection step that there is the axis configuration that is not to be actually used to machine the workpiece in the axis configurations.

According to a fifth aspect of the present invention, in the third or fourth aspect, the method further includes a translation axis correction value decision step and a rotation axis correction value decision step. The translation axis correction value decision step is a step of, if there are a plurality of the used axis configurations determined in the selection step, deciding that the correction value for the translation axis included in the used axis configuration determined to have highest priority of use based on priority determination information for determining priority of use of each of the used axis configurations is the correction value to be added to the translation axis command value in the update step. The correction value is obtained from the correction values calculated for each translation axis included in each of the plurality of the used axis configurations by the translation axis correction value calculation step. The rotation axis correction value decision step is a step of, if there are a plurality of the used axis configurations determined in the selection step, deciding that the correction value for the rotation axis included in the used axis configuration determined to have highest priority of use based on the priority determination information is the correction value to be added to the rotation axis command value in the update step. The correction value is obtained from the correction values calculated for each rotation axis included in each of the plurality of the used axis configurations by the rotation axis correction value calculation step.

An apparatus for controlling a machine tool according to a sixth aspect of the present invention is an apparatus for controlling a machine tool. In the apparatus, a main spindle on which a tool is mounted and a table that holds a workpiece are moved relative to each other by two or more translation axes and at least one rotation axis to machine the workpiece with the tool. At least one of the main spindle and the table is provided in plural number. In the apparatus, an error in a position of the tool with respect to the workpiece due to an error of the machine tool is calculated from a position of the tool in presence of the error of the machine tool, which is obtained by a homogeneous coordinate transformation from a tool coordinate system to a workpiece coordinate system with consideration of the error of the machine, and an ideal position of the tool, which is obtained by the homogeneous coordinate transformation from the tool coordinate system to the workpiece coordinate system without consideration of the error of the machine tool. The error in the position of the tool is corrected to calculate a translation axis command value for controlling the translation axis and a rotation axis command value for controlling the rotation axis. The apparatus includes a selection unit, a translation axis correction value calculation unit, a rotation axis correction value calculation unit, and an update unit. The selection unit selects an arbitrary axis configuration having an arbitrary translation axis included in the two or more translation axes and an arbitrary rotation axis included in the at least one rotation axis. The translation axis correction value calculation unit calculates a correction value for the translation axis for correcting the error in the position of the tool in a command value coordinate system of the translation axis, based on a homogeneous coordinate transformation of the error in the position of the tool from the workpiece coordinate system to the command value coordinate system of the translation axis included in the arbitrary axis configuration selected in the selection unit. The rotation axis correction value calculation unit calculates a correction value for the rotation axis for correcting the error in the position of the tool in a command value coordinate system of the rotation axis, based on the error of the machine tool in a rotation direction of the rotation axis included in the arbitrary axis configuration selected by the selection unit. The update unit updates the translation axis command value by adding the correction value calculated by the translation axis correction value calculation unit to the translation axis command value, and updates the rotation axis command value by adding the correction value calculated by the rotation axis correction value calculation unit to the rotation axis command value.

According to a seventh aspect of the present invention, in the sixth aspect, the error of the machine tool is regarded as a geometric error. The error in the position of the tool is calculated from the position of the tool in presence of the geometric error, which is obtained by the homogeneous coordinate transformation from the tool coordinate system to the workpiece coordinate system with consideration of the geometric error, and the ideal position of the tool, which is obtained by the homogeneous coordinate transformation from the tool coordinate system to the workpiece coordinate system without consideration of the geometric error. The translation axis correction value calculation unit calculates the correction value for the translation axis to correct the error in the position of the tool in the command value coordinate system of the translation axis, based on the homogeneous coordinate transformation of the error in the position of the tool from the workpiece coordinate system to the command value coordinate system of the translation axis included in the arbitrary axis configuration selected by the selection unit. The rotation axis correction value calculation unit calculates the correction value for the rotation axis to correct the error in the position of the tool in the command value coordinate system of the rotation axis, based on the geometric error in the rotation direction of the rotation axis included in the arbitrary axis configuration selected by the selection unit.

According to an eighth aspect of the present invention, in the seventh aspect, the arbitrary translation axis is the translation axis to be actually used to machine the workpiece, and the arbitrary rotation axis is the rotation axis to be actually used to machine the workpiece. The apparatus further includes a storage unit that stores used axis configuration determination information for determining a used axis configuration having the translation axis to be actually used to machine the workpiece and the rotation axis to be actually used to machine the workpiece. The selection unit determines, based on the used axis configuration determination information stored in the storage unit, whether or not there is the used axis configuration in axis configurations which have the translation axis included in the two or more translation axes and the rotation axis included in the at least one rotation axis, and selects the determined used axis configuration as the arbitrary axis configuration. The translation axis correction value calculation unit calculates the correction value for the translation axis based on the homogeneous coordinate transformation of the error in the position of the tool from the workpiece coordinate system to the command value coordinate system of the translation axis included in the used axis configuration selected by the selection unit. The rotation axis correction value calculation unit calculates the correction value for the rotation axis based on the geometric error in the rotation direction of the rotation axis included in the used axis configuration selected by the selection unit.

According to a ninth aspect of the present invention, in the eighth aspect, the apparatus further includes an error decision unit that decides that the error in the position of the tool is to retain a previous error or to be set to zero if it is determined that there is the axis configuration that is not to be actually used to machine the workpiece in the axis configurations.

According to a tenth aspect of the present invention, in the eighth or ninth aspect, priority determination information for determining priority of use of each of the used axis configurations is stored in the storage unit. The apparatus further includes a translation axis correction value decision unit and a rotation axis correction value decision unit. If there are a plurality of the used axis configurations determined by the selection unit, the translation axis correction value decision unit decides that the correction value for the translation axis included in the used axis configuration determined to have highest priority of use based on the priority determination information stored in the storage unit is the correction value to be added to the translation axis command value by the update unit. The correction value is obtained from the correction values calculated for each translation axis included in each of the plurality of the used axis configurations by the translation axis correction value calculation unit. If there are a plurality of the used axis configurations determined by the selection unit, the rotation axis correction value decision unit decides that the correction value for the rotation axis included in the used axis configuration determined to have highest priority of use based on the priority determination information is the correction value to be added to the rotation axis command value by the update unit. The correction value is obtained from the correction values calculated for each rotation axis included in each of the plurality of the used axis configurations by the rotation axis correction value calculation unit.

In the method for controlling the machine tool according to the first aspect of the present invention and the apparatus for controlling the machine tool according to the sixth aspect of the present invention, the correction value for the translation axis to correct the error in the position of the tool in the command value coordinate system for the translation axis can be calculated by a simple method, namely, by merely performing a homogeneous coordinate transformation of the error in the position of the tool with respect to the workpiece due to an error of the machine tool to the command value coordinate system for the translation axis included in the arbitrary axis configuration. Moreover, the correction value for the rotation axis to correct the error in the position of the tool in the command coordinate system of the rotation axis can be calculated by a simple method, namely, by merely using the error of the machine tool in the rotation direction of the rotation axis included in the arbitrary axis configuration. Then, the command value for the translation axis and the command value for the rotation axis can be updated by a simple method, namely, by adding the calculated correction value for the translation axis to the translation axis command value and by adding the calculated correction value for the rotation axis to the rotation axis command value. Combining these simple methods can correct the error of the machine tool in which at least one of the number of main spindles and the number of tables is more than one, and can calculate the command value for the translation axis and the command value for the rotation axis for the arbitrary axis configuration.

According to the second and seventh aspects of the present invention, the correction value for the translation axis to correct the error in the position of the tool in the command value coordinate system for the translation axis can be calculated by a simple method, namely, by merely performing a homogeneous coordinate transformation of the error in the position of the tool with respect to the workpiece due to a geometric error to the command value coordinate system for the translation axis included in the arbitrary axis configuration. Moreover, the correction value for the rotation axis for correcting the error in the position of the tool in the command coordinate system of the rotation axis can be calculated by a simple method, namely, by merely using the geometric error in the rotation direction of the rotation axis included in the arbitrary axis configuration. Then, the command value for the translation axis and the command value for the rotation axis can be updated by a simple method, namely, by adding the calculated correction value for the translation axis to the translation axis command value and by adding the calculated correction value for the rotation axis to the rotation axis command value. Combining these simple methods can correct the geometric error in the machine tool in which at least one of the number of main spindles and the number of tables is more than one, and can calculate the command value for the translation axis and the command value for the rotation axis for the arbitrary axis configuration.

According to the third and eighth aspects of the present invention, the correction values (the correction value for the translation axis and the correction value for the rotation axis) for correcting the error in the position of the tool with respect to the workpiece due to the geometric error can be calculated for the used axis configuration having the translation axis and the rotation axis which are to be actually used to machine the workpiece.

According to the fourth and ninth aspects of the present invention, calculation of the error in the position of the tool with respect to the workpiece due to the geometric error can be omitted for axis configurations which are not actually to be used to machine the workpiece. This can reduce calculation load for calculation of this error.

According to the fifth and tenth aspects of the present invention, if there is a plurality of used axis configurations, it can be decided that the correction value that is used to update the translation axis command value is the correction value for the translation axis included in the used axis configuration having the highest priority of use and that the correction value that is used to update the rotation axis command value is the correction value for the rotation axis included in the used axis configuration having the highest priority of use. Accordingly, when updating the translation axis command value and the rotation axis command value, a plurality of correction values to each command value will not be unnecessarily added. This can prevent excessive correction of the translation axis command value and the rotation axis command value.

### BRIEF DESCRIPTION OF THE DRAWINGS

FIG. 1 is a schematic diagram of a multitasking lathe according to an embodiment of the present invention.

FIG. 2 is a block diagram of a numerical control apparatus that performs a control method according to the embodiment.

FIG. 3 is a flowchart of a process of calculating command values for translation and rotation axes.

FIG. 4 is a flowchart of a process of calculating an error in the position of the distal end point of a tool in a workpiece coordinate system.

FIG. 5 is a flowchart of a process of deciding correction values for the translation and rotation axes in a command value coordinate system.

FIG. 6 is a flowchart of a process of comparing and updating axis configuration parameters indicating the axis configuration number etc.

FIG. 7 is a schematic diagram of a conventional 5-axis control machining center.

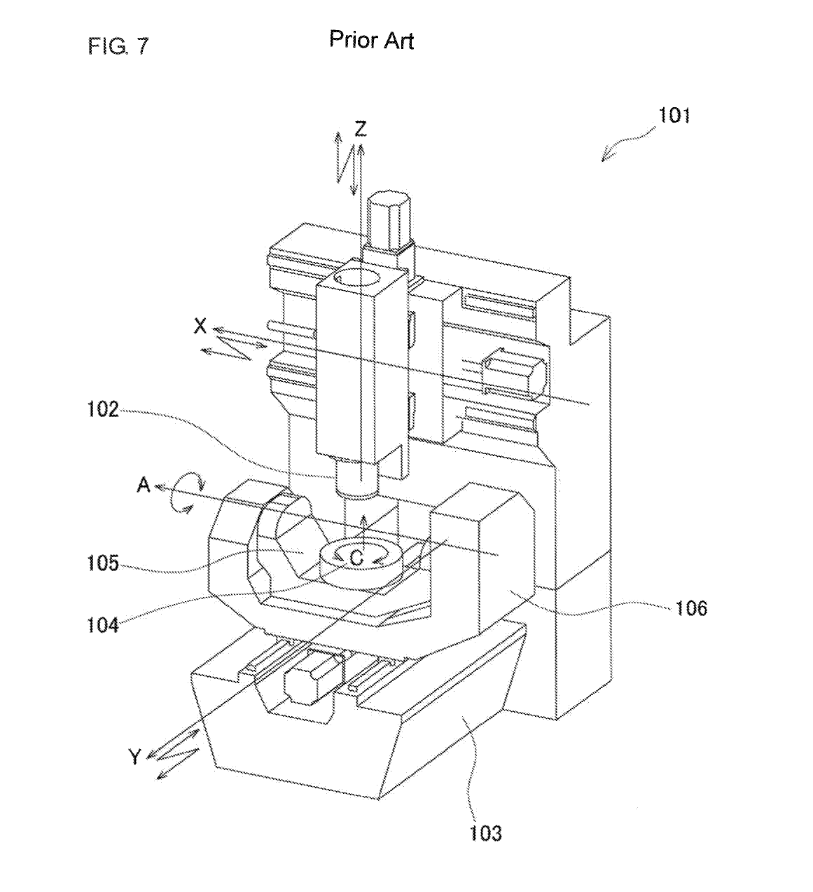

### DETAILED DESCRIPTION OF THE EMBODIMENTS

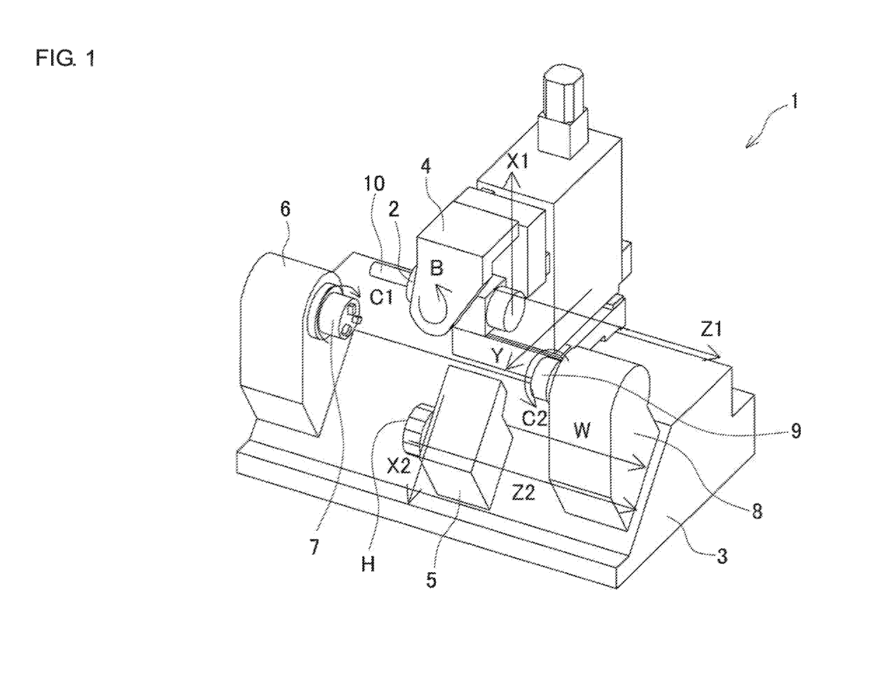

An embodiment of the present invention will be described with reference to FIGS. 1 to 6. A multitasking lathe 1 shown in FIG. 1 is an example of the machine tool in the present invention, and has six translation axes (X1-axis, X2-axis, Y-axis, Z1-axis, Z2-axis, and W-axis) and three rotation axes (B-axis, C1-axis, and C2-axis). A spindle head 2 has three translational degrees of freedom relative to a bed 3 by the X1-, Y-, and Z1-axes that are translation axes perpendicular to each other. The spindle head 2 also has a single rotational degree of freedom by the B-axis serving as a rotation axis included in a first tool rest 4. A second tool rest 5 has two translational degrees of freedom relative to the bed 3 by the X2- and Z2-axes perpendicular to each other. The second tool rest 5 includes a turret head H having various tools mounted thereon.

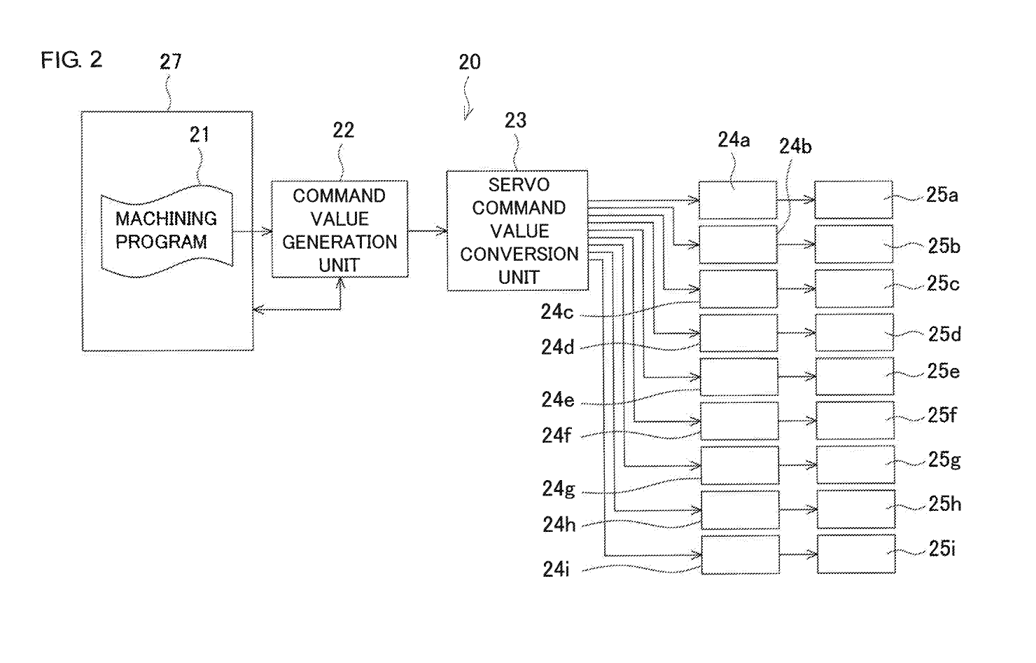

A first headstock 6 is fixed to the bed 3 and has a single rotational degree of freedom by the rotation axis C1. A first main spindle portion 7 included in the first headstock 6 is rotatable about the rotation axis C1, and a workpiece (not shown) can be attached to the first main spindle portion 7. Moreover, a second headstock 8 has a single translational degree of freedom relative to the bed 3 by the W-axis serving as a translation axis parallel to the Z1-axis. The second headstock 8 also has a single rotational degree of freedom by the C2-axis serving as a rotation axis. A second main spindle portion 9 included in the second headstock 8 is rotatable about the rotation axis C2, and a workpiece (not shown) can also be attached to the second main spindle portion 9. The translation axes (X1-axis, X2-axis, Y-axis, Z1-axis, Z2-axis, and W-axis) and the rotation axes (B-axis, C1-axis, and C2-axis) are driven by servomotors 25a to 25i (see FIG. 2) that are controlled by a numerical control apparatus 20 described below. The workpiece is machined into a desired shape with a tool 10 (see FIG. 1) mounted on the spindle head 2 and the tool (not shown) mounted on the turret head H by controlling the relative positions of the tool 10 and the workpiece and the relative positions of the tool mounted on the turret head H and the workpiece. The first headstock 6 and the second headstock 8 are examples of the table in the present invention.

FIG. 2 shows an example of the numerical control apparatus 20 that performs control according to the present embodiment. The numerical control apparatus 20 includes a command value generation unit 22 and a servo command value conversion unit 23. The command value generation unit 22 generates a command value for each axis (B-axis, C1-axis, C2-axis, X1-axis, X2-axis, Y-axis, Z1-axis, Z2-axis, and W-axis) in response to a machining program 21. In the machining program 21, a command coordinate value of the distal end position of the tool 10 etc. is described as a command to move the tool 10 etc. to a machining position when machining a workpiece. The command values thus generated are transmitted to the servo command value conversion unit 23. In response to the command values, the servo command value conversion unit 23 computes a servo command value for each axis and transmits the servo command values to servo amplifiers 24a to 24i corresponding to the axes. The servo amplifiers 24a to 24i corresponding to the axes drive the servomotors 25a to 25i, respectively, so that the relative positions and attitudes of the tool 10 and the tool mounted on the turret head H relative to the first headstock 6 or the second headstock 8 are controlled. The numerical control apparatus 20 further includes a storage unit 27 as shown in FIG. 2. The machining program 21, a geometric error obtained by actual measurement described below, used axis configuration determination parameters AInf1 to AInf3 described below, and axis configuration parameters BInf1 to BInf3 described below are stored in the storage unit 27.

In the present embodiment, the geometric error is defined by a total of six components (δx, δy, δz, α, β, and γ), namely, three directions of relative translation errors and three directions of relative rotation errors between adjacent ones of the axes. In the multitasking lathe 1 of the present embodiment, an axis configuration from the workpiece to the tool 10 which uses a combination of the first tool rest 4 and the first headstock 6 (hereinafter referred to as the “first axis configuration”) is C1-axis-Z1-axis-Y-axis-X1-axis-B-axis. There are 13 geometric errors in the first axis configuration. An axis configuration from the workpiece to the tool 10 which uses a combination of the first tool rest 4 and the second headstock 8 (hereinafter referred to as the “second axis configuration”) is C2-axis-W-axis-Z1-axis-Y-axis-X1-axis-B-axis. There are 15 geometric errors in the second axis configuration. An axis configuration from the workpiece to the tool which uses a combination of the second tool rest 5 and the first headstock 6 (hereinafter referred to as the “third axis configuration”) is C1-axis-Z2-axis-X2-axis. There are six geometric errors in the third axis configuration.

An axis configuration from the workpiece to the tool which uses a combination of the second tool rest 5 and the second headstock 8 (hereinafter referred to as the “fourth axis configuration”) is C2-axis-W-axis-Z2-axis-X2-axis. There are eight geometric errors in the fourth axis configuration.

The 13 geometric errors in the first axis configuration are represented by δx₁₁, δz₁₁, α₁₁, β₁₁, α₁₂, γ₁₂, β₁₃, γ₁₃, α₁₄, δx₁₅, δy₁₅, α₁₅, and β₁₅, where “x”, “y”, and “z” represent names of the axes, respectively, the first subscript represents the axis configuration number, and the second subscript represents the order from the tool 10 toward the workpiece. These geometric errors mean an error in the center position of the B-axis in the X1 direction, an error in the center position of the B-axis in the Z1 direction, squareness between the first headstock 6 and the Y-axis, an error in the origin of the B-axis, squareness between the B-axis and the Z1-axis, squareness between the B-axis and the X1-axis, squareness between the Z1-axis and the X1-axis, squareness between the X1-axis and the Y-axis, squareness between the Y-axis and the Z1-axis, an error in the center position of the C1-axis in the X1 direction, an error in the center position of the C1-axis in the Y direction, squareness between the C1-axis and the Y-axis, and squareness between the C1-axis and the X1-axis, respectively. The 13 geometric errors in the first axis configuration are obtained in advance by actual measurement and stored in the storage unit 27.

The 15 geometric errors in the second axis configuration are represented by δx₂₁, δz₂₁, α₂₁, β₂₁, α₂₂, γ₂₂, β₂₃, γ₂₃, α₂₄, α₂₅, β₂₅, δx₂₆, δy₂₆, α₂₆, and β₂₆ by a method similar to that used for the geometric errors in the first axis configuration. These geometric errors mean an error in the center position of the B-axis in the X1 direction, an error in the center position of the B-axis in the Z1 direction, squareness between the second headstock 8 and the Y-axis, an error in the origin of the B-axis, squareness between the B-axis and the Z1-axis, squareness between the B-axis and the X1-axis, squareness between the Z1-axis and the X1-axis, squareness between the X1-axis and the Y-axis, squareness between the Y-axis and the Z1-axis, squareness between the W-axis and the Y-axis, squareness between the W-axis and the X1-axis, an error in the center position of the C2-axis in the X1 direction, an error in the center position of the C2-axis in the Y direction, squareness between the C2-axis and the Y-axis, and squareness between the C2-axis and the X1-axis, respectively. The 15 geometric errors in the second axis configuration are obtained in advance by actual measurement and stored in the storage unit 27.

The six geometric errors in the third axis configuration are represented by α₃₁, β₃₁, β₃₂, δx₃₃, α₃₃, and β₃₃ by a method similar to that used for the geometric errors in the first axis configuration. These geometric errors are represented by parallelism of the second tool rest 8 relative to a plane perpendicular to the X2-axis, squareness between the second headstock 8 and the X2-axis, squareness between the Z2-axis and the X2-axis, an error in the center position of the C1-axis in the X2 direction, parallelism of the C1-axis relative to a plane perpendicular to the X2-axis, and squareness between the C1-axis and the X2-axis, respectively. The six geometric errors in the third axis configuration are obtained in advance by actual measurement and stored in the storage unit 27.

The eight geometric errors in the fourth axis configuration are represented by α₄₁, β₄₁, β₄₂, α₄₃, β₄₃, δx₄₄, α₄₄, and β₄₄ by a method similar to that used for the geometric errors in the first axis configuration. These geometric errors are represented by parallelism of the second tool rest 8 relative to a plane perpendicular to the X2-axis, squareness between the second headstock 8 and the X2-axis, squareness between the Z2-axis and the X2-axis, parallelism of the W-axis relative to a plane perpendicular to the X2-axis, squareness between the W-axis and the X2-axis, an error in the center position of the C2-axis in the X2 direction, parallelism of the C2-axis relative to a plane perpendicular to the X2-axis, and squareness between the C2-axis and the X2-axis, respectively.

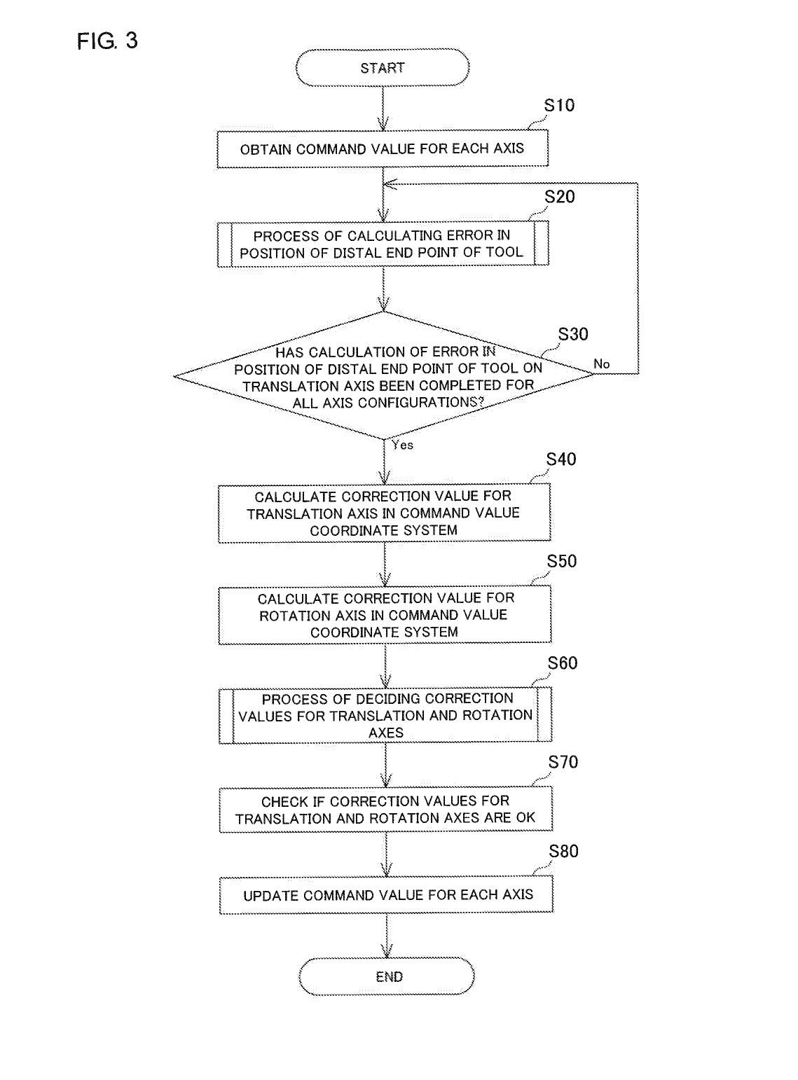

A method for calculating command values for the translation and rotation axes, which is performed by the numerical control apparatus 20, will be described below with reference to FIGS. 3 to 6. The numerical control apparatus 20 (the command value generation unit 22) is capable of calculating the command values corresponding to an arbitrary axis configuration selected from the first to fourth axis configurations by using a calculation program stored in the storage unit 27.

In step S10 of FIG. 3, the command value generation unit 22 obtains a command value for each axis (translation and rotation axes). Specifically, in step S10, the command value generation unit 22 obtains command values for the translation axes (X1-axis, X2-axis, Y-axis, Z1-axis, Z2-axis, and W-axis) and command values for the rotation axes (B-axis, C1-axis, and C2-axis) from the machining program 21 (see FIG. 2). The command value generation unit 22 then stores the obtained command values in the storage unit 27. The command value for the translation axis is an example of the translation axis command value in the present invention, and the command value for the rotation axis is an example of the rotation axis command value in the present invention.

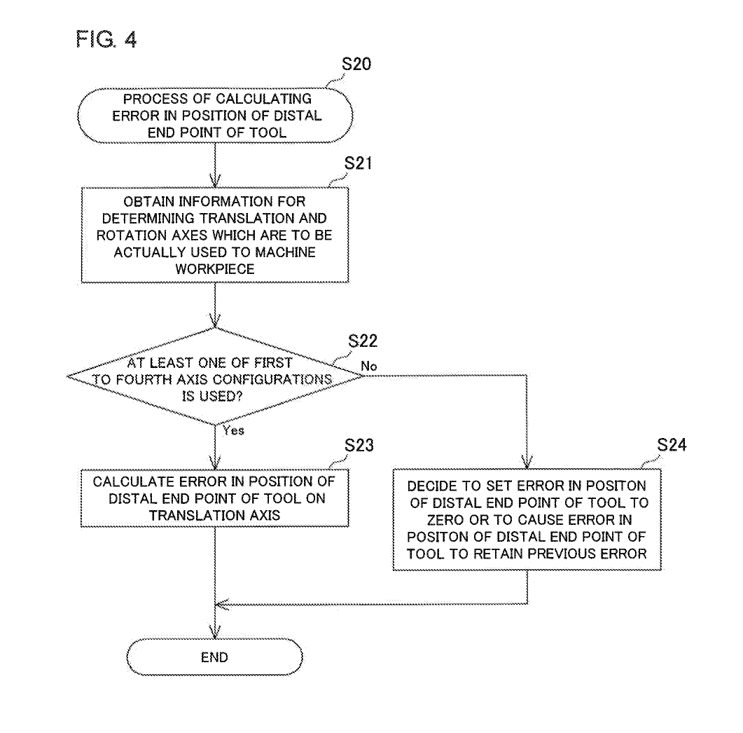

After step S10, the command value generation unit 22 executes in step S20 a process of calculating an error in the position of the distal end point of the tool in a workpiece coordinate system, as described below. In step S20, the command value generation unit 22 performs steps S21 to S24 shown in FIG. 4. In step S21, the command value generation unit 22 obtains information for determining the translation and rotation axes which are to be actually used to machine the workpiece. For example, in step S21, the command value generation unit 22 obtains a program name of the machining program 21 stored in the storage unit 27 (see FIG. 2) for each combination of translation and rotation axes to be actually used. In the present embodiment, the program name of the machining program 21 is different depending on the combination of translation and rotation axes to be actually used. For example, if the program name is “A,” the tool 10 machines the workpiece attached to the first headstock 6 (the first main spindle portion 7) by the first axis configuration (C1-axis-Z1-axis-Y-axis-X1-axis-B-axis). If the program name is “B,” the tool 10 machines the workpiece attached to the second headstock. 8 (the second main spindle portion 9) by the second axis configuration (C2-axis-W-axis-Z1-axis-Y-axis-X1-axis-B-axis). If the program name is “C,” the tool mounted on the turret head H machines the workpiece attached to the first headstock 6 (the first main spindle portion 7) by the third axis configuration (C1-axis-Z2-axis-X2-axis). If the program name is “D,” the tool mounted on the turret head H machines the workpiece attached to the second headstock 8 (the second main spindle portion 9) by the fourth axis configuration (C2-axis-W-axis-Z2-axis-X2-axis).

After step S21, the command value generation unit 22 determines in step S22 whether any one or more of the first to fourth axis configurations are to be used or not. If the program name obtained in step S21 is “A,” the command value generation unit 22 determines in step S22 that the first axis configuration is to be used. If the obtained program name is “B,” the command value generation unit 22 determines that the second axis configuration is to be used. If the obtained program name is “C,” the command value generation unit 22 determines that the third axis configuration is to be used. If the obtained program name is “D,” the command value generation unit 22 determines that the fourth axis configuration is to be used. For example, if the program names obtained in step S21 are “A” and “C,” the command value generation unit 22 determines that the first and third axis configurations are to be used in combination. In the present embodiment, if the program names obtained in step S21 are “A” and “B,” the command value generation unit 22 determines that only the first axis configuration is to be used, so that the tool 10 will not machine the workpiece attached to the second headstock 8. Moreover, if the program names obtained in step S21 are “C” and “D,” the command value generation unit 22 determines that only the third axis configuration is to be used, so that the tool mounted on the turret head H will not machine the workpiece attached to the second headstock 8. The first to fourth axis configurations are examples of the arbitrary axis configuration in the present invention. The Z1-axis, the Y-axis, and the X1-axis in the first axis configuration, the W-axis, the Z1-axis, the Y-axis, and the X1-axis in the second axis configuration, the Z2-axis and the X2-axis in the third axis configuration, and the W-axis, the Z2-axis, and the X2-axis in the fourth axis configuration are examples of the arbitrary translation axis in the present invention. The C1-axis and the B-axis in the first axis configuration, the C2-axis and the B-axis in the second axis configuration, the C1-axis in the third axis configuration, and the C2-axis in the fourth axis configuration are examples of the arbitrary rotation axis in the present invention. Any of the first to fourth axis configurations which has been determined to be used is an example of the used axis configuration in the present invention. The Z1-axis, the Y-axis, and the X1-axis in the first axis configuration that has been determined to be used, the W-axis, the Z1-axis, the Y-axis, and the X1-axis in the second axis configuration that has been determined to be used, the Z2-axis and the X2-axis in the third axis configuration that has been determined to be used, and the W-axis, the Z2-axis, and the X2-axis in the fourth axis configuration that has been determined to be used are examples of the translation axis to be actually used to machine the workpiece in the present invention. The C1-axis and the B-axis in the first axis configuration that has been determined to be used, the C2-axis and the B-axis in the second axis configuration that has been determined to be used, the C1-axis in the third axis configuration that has been determined to be used, and the C2-axis in the fourth axis configuration that has been determined to be used are examples of the rotation axis to be actually used to machine the workpiece in the present invention. The program name is an example of the used axis configuration determination information in the present invention. Step S22 is an example of the selection step in the present invention, and the command value generation unit 22 is an example of the selection unit in the present invention.

If it is determined in step S22 that one of the first to fourth axis configurations is to be used or two or more of the first to fourth axis configurations are to be used in combination, the command value generation unit 22 calculates in step S23 an error in the position of the distal end point of the tool in the workpiece coordinate system of the translation axis, as described below. In the case of converting a tool distal end point vector ^{T}P₁ in a tool coordinate system in the spindle head 2 and a tool distal end point vector ^{T}P₂ in a tool coordinate system in the turret head H of the second tool rest 5 to the workpiece coordinate system in the first headstock 6 and the second headstock 8, a transformation matrix for each axis is given by the following expression 1, where “t₁ (t_{X1}, t_{Y1}, t_{Z1})” represents the length of the tool 10, “t₂ (t_{X2}, t_{X2}, t_{Z2})” represents the length of the tool mounted on the turret head H, and “i” represents each command position for the B-axis, the C-axis (C1-axis and C2-axis), the X-axis (X1-axis and X2-axis), the Y-axis, the Z-axis (Z1-axis and Z2-axis), and the W-axis. The command value generation unit 22 calculates a tool distal end point vector ^{W}P₁ in the workpiece coordinate system in the absence of geometric errors by using the tool distal end point vector ^{T}P₁, the tool distal end point vector ^{T}P₂, and the transformation matrix for each axis M_{B}(i), M_{C}(i), M_{X}(i), M_{Y}(i), M_{Z}(i), and M_{W}(i).

$${M}_{B} ( i ) = [ \begin{matrix}cos i & 0 & sin i & 0 \\ 0 & 1 & 0 & 0 \\ - sin i & 0 & cos i & 0 \\ 0 & 0 & 0 & 1\end{matrix} ] , \\ {M}_{C} ( i ) = [ \begin{matrix}cos i & - sin i & 0 & 0 \\ sin i & cos i & 0 & 0 \\ 0 & 0 & 1 & 0 \\ 0 & 0 & 0 & 1\end{matrix} ] \\ {M}_{X} ( i ) = [ \begin{matrix}1 & 0 & 0 & i \\ 0 & 1 & 0 & 0 \\ 0 & 0 & 1 & 0 \\ 0 & 0 & 0 & 1\end{matrix} ] , \\ {M}_{Y} ( i ) = [ \begin{matrix}1 & 0 & 0 & 0 \\ 0 & 1 & 0 & i \\ 0 & 0 & 1 & 0 \\ 0 & 0 & 0 & 1\end{matrix} ] , \\ {M}_{Z} ( i ) = [ \begin{matrix}1 & 0 & 0 & 0 \\ 0 & 1 & 0 & 0 \\ 0 & 0 & 1 & i \\ 0 & 0 & 0 & 1\end{matrix} ] , \\ {M}_{W} ( i ) = [ \begin{matrix}1 & 0 & 0 & 0 \\ 0 & 1 & 0 & 0 \\ 0 & 0 & 1 & i \\ 0 & 0 & 0 & 1\end{matrix} ] \\ {}_{}^{T}{P}{}_{1}^{} = [ \begin{matrix}- {t}_{X 1} \\ - {t}_{Y 1} \\ - {t}_{Z 1} \\ 1\end{matrix} ] , \\ {}_{}^{T}{P}{}_{2}^{} = [ \begin{matrix}- {t}_{X 2} \\ - {t}_{Y 2} \\ - {t}_{Z 2} \\ 1\end{matrix} ] \qquad [ Expression 1 ]$$

The command value generation unit 22 performs a homogenous coordinate transformation from the tool coordinate system in the absence of geometric errors to the workpiece coordinate system in the first axis configuration in the absence of geometric errors by using the following expression 2. The command value generation unit 22 thus calculates an ideal tool distal end point vector ^{W}P₁₁ in the workpiece coordinate system in the first axis configuration in the absence of geometric errors. The command value generation unit 22 performs a homogenous coordinate transformation from the tool coordinate system in the absence of geometric errors to the workpiece coordinate system in the second axis configuration in the absence of geometric errors by using the following expression 3. The command value generation unit 22 thus calculates an ideal tool distal end point vector ^{W}P₁₂ in the workpiece coordinate system in the second axis configuration in the absence of geometric errors. The command value generation unit 22 performs a homogenous coordinate transformation from the tool coordinate system in the absence of geometric errors to the workpiece coordinate system in the third axis configuration in the absence of geometric errors by using the following expression 4. The command value generation unit 22 thus calculates an ideal tool distal end point vector ^{W}P₁₃ in the workpiece coordinate system in the third axis configuration in the absence of geometric errors. The command value generation unit 22 performs a homogenous coordinate transformation from the tool coordinate system in the absence of geometric errors to the workpiece coordinate system in the fourth axis configuration in the absence of geometric errors by using the following expression 5. The command value generation unit 22 thus calculates an ideal tool distal end point vector ^{W}P₁₄ in the workpiece coordinate system in the fourth axis configuration in the absence of geometric errors. In the expression 2, “c₁” represents a command position for the C1-axis, “z1” represents a command position for the Z1-axis, “y” represents a command position for the Y-axis, “x₁” represents a command position for the X1-axis, and “b” represents a command position for the B-axis. In the expression 3, “c₂” represents a command position for the C2-axis, “w” represents a command position for the W-axis, “z₁” represents a command position for the Z1-axis, “y” represents a command position for the Y-axis, “x₁” represents a command position for the X1-axis, and “b” represents a command position for the B-axis. In the expression 4, “c₁” represents a command position for the C1-axis, “z₂” represents a command position for the Z2-axis, and “x₂” represents a command position for the X2-axis. In the expression 5, “c₂” represents a command position for the C2-axis, “w” represents a command position for the W-axis, “z₂” represents a command position for the Z2-axis, and “x₂” represents a command position for the X2-axis.

^{W}P_{I1}=M_{C}(c₁)·M_{Z}(z₁)·M_{Y}(y)·M_{X}(x₁)·M_{B}(b)·^{T}P₃ [Expression 2]

^{W}P_{I2}=M_{C}(c₂)·M_{W}(w)·M_{Z}(z₁)·M_{Y}(y)·M_{X}(x₁)·M_{B}(b)·^{T}P₃ [Expression 3]

^{W}P_{I3}=M_{C}(c₁)·M_{Z}(z₂)·M_{X}(x₂)·^{T}P₂ [Expression 4]

^{W}P_{I4}=M_{C}(c₂)·M_{W}(w)·M_{Z}(z₂)·M_{X}(x₂)·^{T}P₂ [Expression 5]

In step S23, in the case where there is any geometric error in the multitasking lathe 1, each geometric error is regarded as a relative error between the axes, and a matrix εⱼₖ, given by the following expression 6 using translation errors δx, δy, and δz and rotation errors α, β, and γ of each geometric error stored in the storage unit 27 is a transformation matrix for the geometric error. The command value generation unit 22 performs a homogenous coordinate transformation from the tool coordinate system in the presence of the geometric error to the workpiece coordinate system in the first axis configuration in the presence of the geometric error by using the following expression 7. The expression 7 corresponds to the expression 2 having the matrix εⱼₖ placed between the axes. The command value generation unit 22 thus calculates a tool distal end point vector ^{W}P_{G1} in the workpiece coordinate system in the first axis configuration in the presence of the geometric error. The command value generation unit 22 performs a homogenous coordinate transformation from the tool coordinate system in the presence of the geometric error to the workpiece coordinate system in the second axis configuration in the presence of the geometric error by using the following expression 8. The following expression 8 corresponds to the expression 3 having the matrix εⱼₖ placed between the axes. The command value generation unit 22 thus calculates a tool distal end point vector ^{W}P_{G2} a in the workpiece coordinate system in the second axis configuration in the presence of the geometric error. The command value generation unit 22 performs a homogenous coordinate transformation from the tool coordinate system in the presence of the geometric error to the workpiece coordinate system in the third axis configuration in the presence of the geometric error by using the following expression 9. The expression 9 corresponds to the expression 4 having the matrix εⱼₖ placed between the axes. The command value generation unit 22 thus calculates a tool distal end point vector ^{W}P_{G3} in the workpiece coordinate system in the third axis configuration in the presence of the geometric error. The command value generation unit 22 performs a homogenous coordinate transformation from the tool coordinate system in the presence of the geometric error to the workpiece coordinate system in the fourth axis configuration in the presence of the geometric error by using the following expression 10. The following expression 10 corresponds to the expression 5 having the matrix εⱼₖ placed between the axes. The command value generation unit 22 thus calculates a tool distal end point vector ^{W}P_{G4} in the workpiece coordinate system in the fourth axis configuration in the presence of the geometric error. The first subscript “j” in the matrix εⱼₖ represents the axis configuration number (in this example, first to fourth), and the second subscript “k” in the matrix εⱼₖ represents the order of the axes having a geometric error therebetween from the tool 10 or the tool mounted on the turret head H toward the workpiece.

$${ɛ}_{jk} = [ \begin{matrix}1 & - {γ}_{jk} & {β}_{jk} & δ {x}_{jk} \\ {γ}_{jk} & 1 & - {α}_{jk} & δ {y}_{jk} \\ - {β}_{jk} & {α}_{jk} & 1 & δ {z}_{jk} \\ 0 & 0 & 0 & 1\end{matrix} ] \qquad [ Expression 6 ]$$

^{W}P_{G1}=ε₁₆·M_{C}(c₁)·ε₁₅·M_{Z}(z₁)·ε₁₄·M_{Y}(y)·ε₁₃·M_{X}(x₁)·ε₁₂·M_{B}(b)·ε₁₁·^{T}P₁ [Expression 7]

^{W}P_{G2}=ε₂₇·M_{C}(c₂)·ε₂₆·M_{W}·(w)·ε₂₅·M_{Z}(z₁)·ε₂₄·M_{Y}(y)·ε₂₃·M_{X}(x₁)·ε₂₂·M_{B}(b)·ε₂₁·^{T}P₁ [Expression 8]

^{W}P_{G3}=ε₃₄·M_{C}(c₁)·ε₃₃·M_{Z}(z₂)·ε₃₂·M_{X}(x₂)·ε₃₁·^{T}P₂ [Expression 9]

^{W}P_{G4}=ε₄₅·M_{C}(c₂)·ε₄₄·M_{W}(w)·ε₄₃·M_{Z}(z₂)·ε₄₂·M_{X}(x₂)·ε₄₁·^{T}P₂ [Expression 10]

Subsequently, in step S23, the command value generation unit 22 calculates a position error Δeⱼ of the distal end point of the tool in the workpiece coordinate system by using the following expression 11. If it is determined in step S22 that the first axis configuration is to be used, the command value generation unit 22 calculates in step S23 a position error Δe₁ of the distal end point of the tool in the workpiece coordinate system in the first axis configuration from the difference between the tool distal end point vector ^{W}P_{G1} calculated by the expression 7 and the tool distal end point vector ^{W}P₁₁ calculated by the expression 2 by using the expression 11. If it is determined in step S22 that the second axis configuration is to be used, the command value generation unit 22 calculates in step S23 a position error Δe₂ of the distal end point of the tool in the workpiece coordinate system in the second axis configuration from the difference between the tool distal end point vector ^{W}P_{G2} calculated by the expression 8 and the tool distal end point vector ^{W}P₁₂ calculated by the expression 3 by using the expression 11. If it is determined in step S22 that the third axis configuration is to be used, the command value generation unit 22 calculates in step S23 a position error Δe₃ of the distal end point of the tool in the workpiece coordinate system in the third axis configuration from the difference between the tool distal end point vector ^{W}P_{G3} calculated by the expression 9 and the tool distal end point vector ^{W}P_{I3} calculated by the expression 4 by using the expression 11. If it is determined in step S22 that the fourth axis configuration is to be used, the command value generation unit 22 calculates in step S23 a position error Δe₄ of the distal end point of the tool in the workpiece coordinate system in the fourth axis configuration from the difference between the tool distal end point vector ^{W}P_{G4} calculated by the expression 10 and the tool distal end point vector ^{W}P_{I4} calculated by the expression 5 by using the expression 11. For example, if it is determined in step S22 that both of the first and third axis configurations are to be used, the command value generation unit 22 calculates the position error Δe₁ and the position error Δe₃ in step S23. The position errors Δe₁ to Δe₄ calculated in step S23 are stored in the storage unit 27. Step 23 is thus completed.

$$Δ {e}_{j} = [ \begin{matrix}Δ {x}_{j} \\ Δ {y}_{j} \\ Δ {z}_{j} \\ 1\end{matrix} ] = {}_{}^{W}{P}{}_{Gj}^{} - {}_{}^{W}{P}{}_{Ij}^{} \qquad [ Expression 11 ]$$

If it is determined in step S22 that any one or more of the first to fourth axis configurations are not to be used, the command value generation unit 22 decides in step S24 to set the error in the position of the distal end point of the tool in axis configurations which are not to be used to zero or to cause the error to retain the previous error. The “previous error” means the position error Δe₁ to Δe₄ that has been stored in the storage unit 27 at the time it is determined in step S22 that any one or more of the first to fourth axis configurations are not to be used. Performing step S24 can omit calculation of the position error Δeⱼ of the distal end point of the tool in the workpiece coordinate system regarding the translation axes which are not to be used to machine the workpiece. Step S24 is an example of the error decision step in the present invention. The command value generation unit 22 is an example of the error decision unit in the present invention. Of the first to fourth axis configurations, any axis configuration that is determined not to be used in step S22 is an example of the axis configuration that is not to be actually used to machine the workpiece in the present invention.

After step S20, the command value generation unit 22 determines in step S30 in FIG. 3 whether calculation of the error in the position of the distal end point of the tool on the translation axis has been completed for all the axis configurations or not. In this example, the command value generation unit 22 determines whether the position errors Δe₁ to Δe₄ which correspond to the axis configuration determined to be used in step S22 have been stored in the storage unit 27 or not. If it is determined in step S30 that the position errors Δe₁ to Δe₄ which correspond to this axis configuration have not been stored in the storage unit 27 and that calculation of the error in the position of the distal end point of the tool has not been completed for all of the axis configurations, the command value generation unit 22 performs step S20.

If it is determined in step S30 that calculation of the error in the position of the distal end point of the tool on the translation axis has been completed for all of the axis configurations, the command value generation unit 22 converts the error in the position of the distal end point of the tool on the translation axis from the workpiece coordinate system to a command value coordinate system serving as a coordinate system of a command value for the translation axis (X1-axis, X2-axis, Y-axis, Z1-axis, Z2-axis, and W-axis) included in each of the first to fourth axis configurations determined to be used in step S22, and calculates a correction value for the translation axis in the command value coordinate system in step S40 as described below. In the first axis configuration of the present embodiment, the command value coordinate system is located between the C1-axis and the Z1-axis, namely, between the first rotation axis and the first translation axis on the workpiece side. In the second axis configuration, the command value coordinate system is located between the C2-axis and the W-axis, namely, between the first rotation axis and the first translation axis on the workpiece side. In the third axis configuration, the command value coordinate system is located between the C1-axis and the Z2-axis, namely, between the first rotation axis and the first translation axis on the workpiece side. In the fourth axis configuration, the command value coordinate system is located between the C2-axis and the W-axis, namely, between the first rotation axis and the first translation axis on the workpiece side. In step S40, the command value generation unit 22 performs a homogeneous coordinate transformation from the workpiece coordinate system to the command value coordinate system by using the following expression 12. The command value generation unit 22 thus calculates a correction value vector ΔCompⱼ for the translation axis in the command value coordinate system which cancels the error in the position of the distal end point of the tool. In the expression 12, “j” represents the axis configuration number (in this example, 1 to 4). In the case of j=1, 3, “m” represents a command position for the rotation axis C1. In the case of j==2, 4, “m” represents a command position for the rotation axis C2. If it is determined in step S22 that the first axis configuration is to be used, the command value generation unit 22 calculates in step S40 a correction value vector ΔComp₁ for the translation axis in the command value coordinate system in the first axis configuration by using the expression 12. If it is determined in step S22 that the second axis configuration is to be used, the command value generation unit 22 calculates in step S40 a correction value vector ΔComp₂ for the translation axis in the command value coordinate system in the second axis configuration by using the expression 12. If it is determined in step S22 that the third axis configuration is to be used, the command value generation unit 22 calculates in step S40 a correction value vector ΔComp₃ for the translation axis in the command value coordinate system in the third axis configuration by using the expression 12. If it is determined in step S22 that the fourth axis configuration is to be used, the command value generation unit 22 calculates in step S40 a correction value vector ΔComp₄ for the translation axis in the command value coordinate system in the fourth axis configuration by using the expression 12. For example, if it is determined in step S22 that both of the first and third axis configurations are to be used, the command value generation unit 22 calculates the correction value vectors ΔComp₁ and ΔComp₃ in step S40. In step S40, the command value generation unit 22 stores the calculated correction value vectors ΔComp₁ to ΔComp₄ in the storage unit 27. Step 40 is an example of the translation axis correction value calculation step in the present invention, and the command value generation unit 22 is an example of the translation axis correction value calculation unit in the present invention.

$$Δ {Comp}_{j} = [ \begin{matrix}Δ {Cx}_{j} \\ Δ {Cy}_{j} \\ Δ {Cz}_{j} \\ 1\end{matrix} ] = - {{M}_{C} ( m )}^{- 1} \cdot Δ {e}_{j} \qquad [ Expression 12 ]$$

After step S40, the command value generation unit 22 calculates in step S50 correction values for the C-axis (C1-axis, C2-axis) and the B-axis in a command value coordinate system serving as a coordinate system of command values for the C-axis (C1-axis, C2-axis) and the B-axis which are the rotation axes included in each of the first to fourth axis configurations determined to be used in step S22. In step S50, the command value generation unit 22 calculates a correction value ΔCcⱼ for the C-axis in the command value coordinate system and a correction value ΔCbⱼ for the B-axis in the command value coordinate system by the following expression 13 that uses the rotation errors γ, β of the C-axis and the B-axis. If it is determined in step S22 that the first axis configuration is to be used, the command value generation unit 22 calculates in step S50 a correction value ΔCc₁ for the C1-axis and a correction value ΔCb₁ for the B-axis in the command value coordinate system in the first axis configuration by using the expression 13. If it is determined in step S22 that the second axis configuration is to be used, the command value generation unit 22 calculates in step S50 a correction value ΔCc₂ for the C2-axis and a correction value ΔCb₂ for the B-axis in the command value coordinate system in the second axis configuration by using the expression 13. If it is determined in step S22 that the third axis configuration is to be used, the command value generation unit 22 calculates in step S50 a correction value ΔCc₃ for the C1-axis in the command value coordinate system in the third axis configuration by using the expression 13. If it is determined in step S22 that the fourth axis configuration is to be used, the command value generation unit 22 calculates in step S50 a correction value ΔCc₄ for the C2-axis in the command value coordinate system in the fourth axis configuration by using the expression 13. For example, if it is determined in step S22 that both of the first and third axis configurations are to be used, the command value generation unit 22 calculates the correction values ΔCc₁, ΔCc₃ and the correction value ΔCb₁ in step S50. In step S50, the command value generation unit 22 stores the calculated correction values ΔCc₁ to ΔCc₄ and the calculated correction values ΔCb₁, ΔCb₂ in the storage unit 27. Step S50 is an example of the rotation axis correction value calculation step in the present invention, and the command value generation unit 22 is an example of the rotation axis correction value calculation unit in the present invention.

$$\{ \begin{matrix}Δ {Cc}_{j} = - {\sum }_{k = Is 1}^{Ie 1} {γ}_{jk} \\ Δ {Cb}_{j} = - {\sum }_{k = Is 2}^{Ie 2} {β}_{jk}\end{matrix} \qquad [ Expression 13 ]$$

In the expression 13, “Is1,” “Ie1,” “Is2,” and “Ie2” are as shown in the table below.

| j (Axis Configuration) | Is1 | Ie1 | Is2 | Ie2 |
|---|---|---|---|---|
| 1 | 2 | 6 | 1 | 5 |
| 2 | 2 | 7 | 1 | 6 |
| 3 | 1 | 4 | | |
| 4 | 1 | 5 | | |

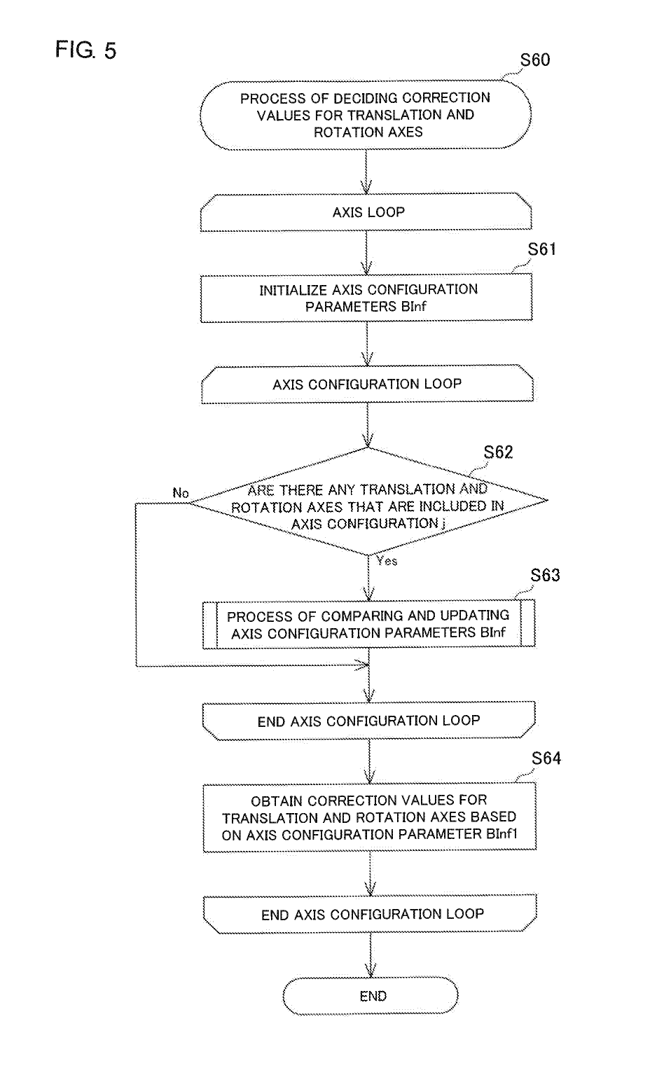

After step S50, the command value generation unit 22 performs in step S60 a process of deciding the correction values for the translation and rotation axes in the command value coordinate system according to the axis configuration determined to be used in step S22, as described below. In step S60, the command value generation unit 22 decides by steps S61 to S64 in FIG. 5 the correction value for each translation axis (X1-axis, X2-axis, Y-axis, Z1-axis, Z2-axis, and W-axis) and the correction value for each rotation axis (B-axis, C1-axis, and C2-axis) of the multitasking lathe 1 in an axis loop for the axis configuration determined to be used in step S22. Procedures for deciding the correction value for the X1-axis and the correction value for the C1-axis according to the first axis configuration will be described below by way of example.

In step S61, the command value generation unit 22 initializes axis configuration parameters BInf stored in the storage unit 27. In step S61, the command value generation unit 22 sets the axis configuration parameter BInf1 to “0,” sets the axis configuration parameter BInf2 to “off,” and sets the axis configuration parameter BInf3 to “99.” The axis configuration parameter BInf1 is a parameter indicating the axis configuration number. The axis configuration parameter BInf2 is a parameter indicating that this axis configuration is to be actually used to machine the workpiece when it is set to “on.” The axis configuration parameter BInf3 is a parameter indicating the priority of use of the axis configuration that is to be used to machine the workpiece.

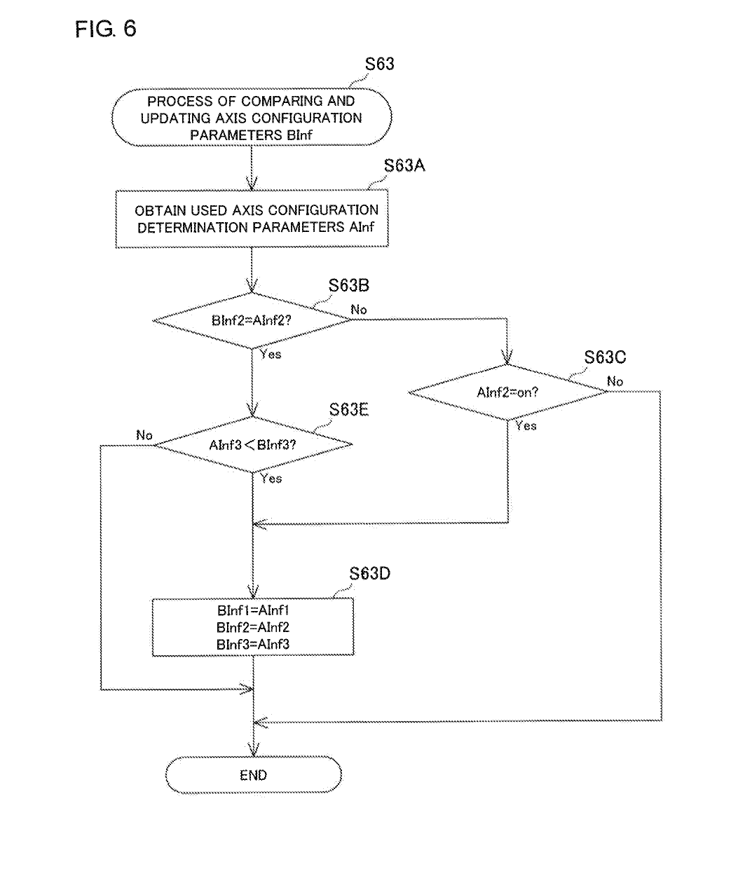

After step S61, the command value generation unit 22 determines in step S62 whether there are any translation and rotation axes that are included in the axis configuration j (in this example, the first axis configuration). If it is determined in step S62 that the X1-axis is a translation axis included in the first axis configuration or that the C1-axis is a rotation axis included in the first axis configuration, the command value generation unit 22 performs in step S63 a process of comparing and updating the axis configuration parameters BInf as described below. In step S63, the command value generation unit 22 performs steps S63A to S63E shown in FIG. 6. The command value generation unit 22 obtains in step S63A the used axis configuration determination parameters AInf for determining the axis configuration to be actually used to machine the workpiece. For example, in step S63A, the command value generation unit 22 obtains from the storage unit 27 the used axis configuration determination parameters AInf stored in the storage unit 27 according to correspond to the machining program 21. In this example, if the program name of the machining program 21 stored in the storage unit 27 is “A” and it is determined that the workpiece is to be machined by the first axis configuration, the command value generation unit 22 obtains the used axis configuration determination parameter AInf1 that has been set to “1,” the used axis configuration determination parameter AInf2 that has been set to “on,” and the used axis configuration determination parameter AInf3 that has been set to “1.” The used axis configuration determination parameter AInf1 is a parameter indicating the axis configuration number. The used axis configuration determination parameter AInf2 is a parameter indicating that this axis configuration is to be actually used to machine the workpiece when it is set to “on.” The used axis configuration determination parameter AInf3 is a parameter indicating the priority of use of the axis configuration that is to be used to machine the workpiece.

After step S63A, the command value generation unit 22 determines in step S63B whether or not both the axis configuration parameter BInf2 initialized in step S61 (see FIG. 5) and the used axis configuration determination parameter AInf2 obtained in step S63A have the same value, namely, either “off” or “on.” In this example, since the axis configuration parameter BInf2 is “off” and the used axis configuration determination parameter AInf2 is “on,” it is determined that the axis configuration parameter BInf2 and the used axis configuration determination parameter AInf2 do not have the same value. The command value generation unit 22 then determines in step S63C whether the used axis configuration determination parameter AInf2 has been set to “on” or not. In this example, since the used axis configuration determination parameter AInf2 has been set to “on,” the command value generation unit 22 updates in step S63D the axis configuration parameters BInf1, BInf2, and BInf3 by setting the axis configuration parameter BInf1 to the same value “1” as the used axis configuration determination parameter AInf1, setting the axis configuration parameter BInf2 to the same value “on” as the used axis configuration determination parameter AInf2, and setting the axis configuration parameter BInf3 to the same value “1” as the used axis configuration determination parameter AInf3. This means that the workpiece is to be machined by the first axis configuration having the highest priority of use. Step S63 for the first axis configuration is thus completed.

In the present embodiment, if it is determined in step S22 that both of the first and third axis configurations are to be used, the command value generation unit 22 performs steps S63A to A63E for the third axis configuration as well after updating the axis configuration parameters BInf1 to BInf3 for the first axis configuration, as described below. If the program name of the machining program 21 stored in the storage unit 27 is “C” and it is determined that the workpiece is to be machined by the third axis configuration, the command value generation unit 22 obtains in step S63A the used axis configuration determination parameter AInf1 that has been set to “3,” the used axis configuration determination parameter AInf2 that has been set to “on,” and the used axis configuration determination parameter AInf3 that has been set to “3.” The used axis configuration determination parameter AInf1 is a parameter indicating the axis configuration number. The used axis configuration determination parameter AInf2 is a parameter indicating that this axis configuration is to be actually used to machine the workpiece when it is set to “on.” The used axis configuration determination parameter AInf3 is a parameter indicating the priority of use of the axis configuration that is to be used to machine the workpiece.

After step S63A, the command value generation unit 22 determines in step S63B whether the axis configuration parameter BInf2 updated in step S63D for the first axis configuration and the used axis configuration determination parameter AInf2 obtained in step S63A for the third axis configuration have the same value or not. In this example, since both the axis configuration parameter BInf2 and the used axis configuration determination parameter AInf2 are “on,” it is determined that the axis configuration parameter BInf2 and the used axis configuration determination parameter AInf2 have the same value. The command value generation unit 22 then determines in step S63E whether the value of the used axis configuration determination parameter AInf3 for the third axis configuration is smaller than that of the axis configuration parameter BInf3 updated in step S63D for the first axis configuration or not. In this example, since the value “3” of the used axis configuration determination parameter AInf3 is larger than the value “1” of the axis configuration parameter BInf3, the command value generation unit 22 does not perform step S63D, and step S63 is terminated. In this manner, in the case of using the plurality of first and third axis configurations having different priorities of use, the used axis configuration determination parameters AInf1 to AInf3 of the first axis configuration having the highest priority of use are set to the axis configuration parameters BInf1 to BInf3. Step S63 for the third axis configuration is thus completed. The axis configuration parameter AInf2 indicating the priority of use of the axis configuration to be used to machine the workpiece is an example of the priority determination information in the present invention.

After step S63, the command value generation unit 22 obtains the correction values for the translation and rotation axes included in the first axis configuration from the storage unit 27 in step S64 of FIG. 5, because the axis configuration parameter BInf1 indicating the axis configuration number has been set to the value “1.” In this example, the command value generation unit 22 obtains the correction value vector ΔComp₁ for the X1-axis and the correction value ΔCc₁ for the C1-axis from the storage unit 27. Step S60 is thus completed. Step S64 is an example of the translation axis correction value decision step and the rotation axis correction value decision step in the present invention. The command value generation unit 22 is an example of the translation axis correction value decision unit and the rotation axis correction value decision unit in the present invention.

After step S60, the command value generation unit 22 checks in step S70 in FIG. 3 if the correction value for the translation axis in the command value coordinate system obtained in step S60 (step S64) is ok, and if the correction value for the rotation axis in the command value coordinate system obtained in step S60 (step S64) is ok. In this example, the command value generation unit 22 checks if each of the magnitude of the correction value vector ΔComp₁ for the X1-axis and the correction value ΔCc₁ for the C1-axis is larger than a preset upper limit threshold or smaller than a preset lower limit threshold. After it is confirmed that each of the magnitude of the correction value vector ΔComp₁ and the correction value ΔCc₁ is not larger than the upper limit threshold and not smaller than the lower limit threshold, the command value generation unit 22 stores the correction value vector ΔComp₁ and the correction value ΔCc₁ in the storage unit 27. On the other hand, if it is confirmed that each of the magnitude of the correction value vector ΔComp₁ and the correction value ΔCc₁ is larger than the upper limit threshold or smaller than the lower limit threshold, the command value generation unit 22 does not store the correction value vector ΔComp₁ and the correction value ΔCc₁ in the storage unit 27, and causes a lamp provided in the multitasking lathe 1 to emit light in order to notify the user of the abnormal correction values for the X1-axis and the C1-axis.

After step S70, the command value generation unit 22 updates the command value for each axis (translation and rotation axes) in step S80. In this example, the command value generation unit 22 adds the magnitude of the correction value vector ΔComp₁ stored in the storage unit 27 in step S70 to the command value for the X1-axis obtained and stored in the storage unit 27 in step S10. The correction value for the X1-axis (translation axis) is updated in this manner. In step S80, the command value generation unit 22 also adds the correction value ΔCc₁ for the C1-axis stored in the storage unit 27 in step S70 to the command value for the C1-axis obtained and stored in the storage unit 27 in step S10. The correction value for the C1-axis (rotation axis) is updated in this manner. In the present embodiment, the procedures for updating the command value for the X1-axis and the command value for the C1-axis are described by way of example. However, the correction value for each translation axis (X2-axis, Y-axis, Z1-axis, Z2-axis, and W-axis) and the correction value for each rotation axis (B-axis and C2-axis) included in each of the first to fourth axis configurations determined to be used in step S22 may be obtained in step S60 (see FIGS. 3 and 5), and then the command value for each axis (X2-axis, Y-axis, Z1-axis, Z2-axis, W-axis, B-axis, and C2-axis) may be updated in step S80. Step S80 is an example of the update step in the present invention, and the command value generation unit 22 is an example of the update unit in the present invention.

### Effects of the Present Embodiment

In the method and apparatus for controlling the multitasking lathe 1 according to the present embodiment, the command value generation unit 22 can calculate in step S40 the correction value (correction value vector ΔComp) for correcting the position error Δeⱼ in the command value coordinate system for the translation axis by a simple method, namely, by merely performing a homogeneous coordinate transformation of the position error Δeⱼ of the distal end point of the tool 10 etc. with respect to the workpiece on the translation axis due to a geometric error to the command value coordinate system for the translation axis included in each of the first to fourth axis configurations determined to be used in step S22.

Moreover, the command value generation unit 22 can calculate in step S50 the correction value ΔCcⱼ, ΔCbⱼ for the rotation axis in the command coordinate system of the rotation axis by a simple method, namely, by merely using the rotation error γ, β of the rotation axis included in each of the first to fourth axis configurations determined to be used.

Then, the command value generation unit 22 can update in step S80 the command value for the translation axis and the command value for the rotation axis by a simple method, namely, by adding the magnitude of the correction value vector ΔComp₁ to the command value for controlling the translation axis (X1-axis, X2-axis, Y-axis, Z1-axis, Z2-axis, and W-axis) and by adding the correction value ΔCcⱼ, ΔCbⱼ for the rotation axis to the command value for controlling the rotation axis (B-axis, C1-axis, and C2-axis). Combining these simple methods allows the command value generation unit 22 to correct a geometric error of the multitasking lathe 1 and to calculate the command value for the translation axis and the command value for the rotation axis for each of the first to fourth axis configurations.

The command value generation unit 22 can calculate in step S40 the correction value vector ΔCompⱼ for the translation axis included in the axis configuration and the correction value ΔCcⱼ, ΔCbⱼ for the rotation axis included in the axis configuration, according to the first to fourth axis configurations determined to be actually used to machine the workpiece.

Moreover, if it is determined in step S22 that any one or more of the first to fourth axis configurations are not to be used, the command value generation unit 22 decides in step S24 to set the position error Δeⱼ of the distal end point of the tool 10 or the distal end point of the tool mounted on the turret head H in the axis configurations which are not to be used to zero or to cause the position error Δeⱼ to retain the previous error. Calculation of the position error Δeⱼ in the workpiece coordinate system can be omitted for the axis configurations which are not to be used. This can reduce calculation load for calculation of the position error Δeⱼ.

Moreover, if it is decided in step S22 to cause the position error Δeⱼ to retain the previous error, the difference between the position error Δeⱼ decided to retain the previous error and the position error Δeⱼ that is calculated in the case where it is determined that the axis configuration determined not to be used is to be used next time can be reduced as compared to the case where it is decided in step S22 to set the position error Δeⱼ to zero. Accordingly, if it is determined during machining of the workpiece that the axis configuration determined not to be used is to be used, a change in the correction value for the translation axis which is calculated for the position error Δeⱼ can be reduced. This can suppress formation of a stepped portion on the machining surface of the workpiece when machining the workpiece based on the sum of the command value for the translation axis and this correction value.

Moreover, for example, if it is determined in step S22 that both of the axis first and third configurations are to be used, the command value generation unit 22 can decide that the correction value vector ΔComp₁ that is used to update the command value for the X1-axis (translation axis) in step S80 is the correction value vector ΔComp₁ for the X1-axis included in the first axis configuration having the highest priority of use for machining the workpiece out of the first and third configurations, and can decide that the correction value ΔCc₁ that is used to update the command value for the C1-axis (rotation axis) in step S80 is the correction value ΔCc₁ for the C1-axis included in the first axis configuration having the highest priority of use out of the first and third configurations. Accordingly, when updating the command value for the C1-axis, weighted addition of a plurality of correction values ΔCc₁ (the correction values ΔCc₁ for both the first and third configurations) to this command value will not be performed. This can prevent excessive correction of the command value for the C1-axis.

The present invention is not limited to the above embodiment, and can be embodied by partially modifying the configuration as appropriate without departing from the spirit and scope of the invention. The above embodiment is described with respect to an example in which the correction value for each translation axis included in the axis configuration and the correction value for each rotation axis included in the axis configuration are obtained in the axis loop of step S60 only for the axis configuration determined to be used in step S22. However, the present invention is not limited to this. For example, the axis configuration may be sequentially changed from the first axis configuration to the fourth axis configuration in the axis loop of step S60 to obtain the correction values for all the translation axes and the correction values for all the rotation axes included in the first to fourth axis configurations, and then the correction value for the translation axis included in the axis configuration to be actually used to machine the workpiece and the correction value for the rotation axis included in this axial configuration may be selected from all of the obtained correction values based on the axis configuration parameters BInf1 to BInf3.

The above embodiment is described with respect to an example in which the present invention is applied to correcting a geometric error of the multitasking lathe 1 to calculate a command value for the translation axis and a command value for the rotation axis. However, the present invention is also applicable to correcting an error of the multitasking lathe 1 other than geometric errors to calculate a correction value for the translation axis and a correction value for the rotation axis. Moreover, the above embodiment is described with respect to an example in which the present invention is applied to the multitasking lathe 1 including the plurality of tool rests 4, 5 and the plurality of headstocks 6, 8. However, the present invention is not limited to this. For example, the present invention is also applicable to a multitasking lathe in which one of the number of tool rests and the number of headstocks is more than one or a multitasking lathe in which the second tool rest has three translational degrees of freedom and two rotational degrees of freedom unlike the multitasking lathe 1 of the embodiment. The present invention is also applicable to, e.g., a multi-axis machining center.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

What is claimed is:

1. A method for controlling a machine tool in which a main spindle on which a tool is mounted and a table that holds a workpiece are moved relative to each other by two or more translation axes and at least one rotation axis to machine the workpiece with the tool, and at least one of the main spindle and the table is provided in plural number, wherein
an error in a position of the tool with respect to the workpiece due to an error of the machine tool is calculated from a position of the tool in presence of the error of the machine tool, which is obtained by a homogeneous coordinate transformation from a tool coordinate system to a workpiece coordinate system with consideration of the error of the machine tool, and an ideal position of the tool, which is obtained by the homogeneous coordinate transformation from the tool coordinate system to the workpiece coordinate system without consideration of the error of the machine tool, and the error in the position of the tool is corrected to calculate a translation axis command value for controlling the translation axis and a rotation axis command value for controlling the rotation axis, the method comprising:
a selection step of selecting an arbitrary axis configuration having an arbitrary translation axis included in the two or more translation axes and an arbitrary rotation axis included in the at least one rotation axis;
a translation axis correction value calculation step of calculating a correction value for the translation axis for correcting the error in the position of the tool in a command value coordinate system of the translation axis, based on a homogeneous coordinate transformation of the error in the position of the tool from the workpiece coordinate system to the command value coordinate system of the translation axis included in the arbitrary axis configuration selected in the selection step;
a rotation axis correction value calculation step of calculating a correction value for the rotation axis for correcting the error in the position of the tool in a command value coordinate system of the rotation axis, based on the error of the machine tool in a rotation direction of the rotation axis included in the arbitrary axis configuration selected in the selection step; and
an update step of updating the translation axis command value by adding the correction value calculated in the translation axis correction value calculation step to the translation axis command value, and updating the rotation axis command value by adding the correction value calculated in the rotation axis correction value calculation step to the rotation axis command value.

2. The method according to claim 1, wherein
the error of the machine tool is regarded as a geometric error,
the error in the position of the tool is calculated from the position of the tool in presence of the geometric error, which is obtained by the homogeneous coordinate transformation from the tool coordinate system to the workpiece coordinate system with consideration of the geometric error, and the ideal position of the tool, which is obtained by the homogeneous coordinate transformation from the tool coordinate system to the workpiece coordinate system without consideration of the geometric error,
in the translation axis correction value calculation step, the correction value for the translation axis for correcting the error in the position of the tool in the command value coordinate system of the translation axis is calculated based on the homogeneous coordinate transformation of the error in the position of the tool from the workpiece coordinate system to the command value coordinate system of the translation axis included in the arbitrary axis configuration selected in the selection step, and
in the rotation axis correction value calculation step, the correction value for the rotation axis for correcting the error in the position of the tool in the command value coordinate system of the rotation axis is calculated based on the geometric error in the rotation direction of the rotation axis included in the arbitrary axis configuration selected in the selection step.

3. The method according to claim 2, wherein
the arbitrary translation axis is the translation axis to be actually used to machine the workpiece, and the arbitrary rotation axis is the rotation axis to be actually used to machine the workpiece,
in the selection step, it is determined, based on used axis configuration determination information for determining a used axis configuration having the translation axis to be actually used to machine the workpiece and the rotation axis to be actually used to machine the workpiece, whether or not there is the used axis configuration in axis configurations which have the translation axis included in the two or more translation axes and the rotation axis included in the at least one rotation axis, and the determined used axis configuration is selected as the arbitrary axis configuration,
in the translation axis correction value calculation step, the correction value for the translation axis is calculated based on the homogeneous coordinate transformation of the error in the position of the tool from the workpiece coordinate system to the command value coordinate system of the translation axis included in the used axis configuration selected in the selection step, and
in the rotation axis correction value calculation step, the correction value for the rotation axis is calculated based on the geometric error in the rotation direction of the rotation axis included in the used axis configuration selected in the selection step.

4. The method according to claim 3, further comprising:
an error decision step of deciding that the error in the position of the tool is to retain a previous error or to be set to zero if it is determined in the selection step that there is the axis configuration that is not to be actually used to machine the workpiece in the axis configurations.

5. The method according to claim 3, further comprising:
a translation axis correction value decision step of, if there are a plurality of the used axis configurations determined in the selection step, deciding that the correction value for the translation axis included in the used axis configuration determined to have highest priority of use based on priority determination information for determining priority of use of each of the used axis configurations is the correction value to be added to the translation axis command value in the update step, the correction value being obtained from the correction values calculated for each translation axis included in each of the plurality of the used axis configurations by the translation axis correction value calculation step; and
a rotation axis correction value decision step of, if there are a plurality of the used axis configurations determined in the selection step, deciding that the correction value for the rotation axis included in the used axis configuration determined to have highest priority of use based on the priority determination information is the correction value to be added to the rotation axis command value in the update step, the correction value being obtained from the correction values calculated for each rotation axis included in each of the plurality of the used axis configurations by the rotation axis correction value calculation step.

6. The method according to claim 4, further comprising:
a translation axis correction value decision step of, if there are a plurality of the used axis configurations determined in the selection step, deciding that the correction value for the translation axis included in the used axis configuration determined to have highest priority of use based on priority determination information for determining priority of use of each of the used axis configurations is the correction value to be added to the translation axis command value in the update step, the correction value being obtained from the correction values calculated for each translation axis included in each of the plurality of the used axis configurations by the translation axis correction value calculation step; and
a rotation axis correction value decision step of, if there are a plurality of the used axis configurations determined in the selection step, deciding that the correction value for the rotation axis included in the used axis configuration determined to have highest priority of use based on the priority determination information is the correction value to be added to the rotation axis command value in the update step, the correction value being obtained from the correction values calculated for each rotation axis included in each of the plurality of the used axis configurations by the rotation axis correction value calculation step.

7. An apparatus for controlling a machine tool in which a main spindle on which a tool is mounted and a table that holds a workpiece are moved relative to each other by two or more translation axes and at least one rotation axis to machine the workpiece with the tool, at least one of the main spindle and the table is provided in plural number, wherein
an error in a position of the tool with respect to the workpiece due to an error of the machine tool is calculated from a position of the tool in presence of the error of the machine tool, which is obtained by a homogeneous coordinate transformation from a tool coordinate system to a workpiece coordinate system with consideration of the error of the machine tool, and an ideal position of the tool, which is obtained by the homogeneous coordinate transformation from the tool coordinate system to the workpiece coordinate system without consideration of the error of the machine tool, and the error in the position of the tool is corrected to calculate a translation axis command value for controlling the translation axis and a rotation axis command value for controlling the rotation axis, the apparatus comprising:
a selection unit that selects an arbitrary axis configuration having an arbitrary translation axis included in the two or more translation axes and an arbitrary rotation axis included in the at least one rotation axis;
a translation axis correction value calculation unit that calculates a correction value for the translation axis for correcting the error in the position of the tool in a command value coordinate system of the translation axis, based on a homogeneous coordinate transformation of the error in the position of the tool from the workpiece coordinate system to the command value coordinate system of the translation axis included in the arbitrary axis configuration selected in the selection unit;
a rotation axis correction value calculation unit that calculates a correction value for the rotation axis for correcting the error in the position of the tool in a command value coordinate system of the rotation axis, based on the error of the machine tool in a rotation direction of the rotation axis included in the arbitrary axis configuration selected by the selection unit; and
an update unit that updates the translation axis command value by adding the correction value calculated by the translation axis correction value calculation unit to the translation axis command value, and updates the rotation axis command value by adding the correction value calculated by the rotation axis correction value calculation unit to the rotation axis command value.

8. The apparatus according to claim 7, wherein
the error of the machine tool is regarded as a geometric error,
the error in the position of the tool is calculated from the position of the tool in presence of the geometric error, which is obtained by the homogeneous coordinate transformation from the tool coordinate system to the workpiece coordinate system with consideration of the geometric error, and the ideal position of the tool, which is obtained by the homogeneous coordinate transformation from the tool coordinate system to the workpiece coordinate system without consideration of the geometric error,
the translation axis correction value calculation unit calculates the correction value for the translation axis for correcting the error in the position of the tool in the command value coordinate system of the translation axis based on the homogeneous coordinate transformation of the error in the position of the tool from the workpiece coordinate system to the command value coordinate system of the translation axis included in the arbitrary axis configuration selected by the selection unit, and
the rotation axis correction value calculation unit calculates the correction value for the rotation axis for correcting the error in the position of the tool in the command value coordinate system of the rotation axis based on the geometric error in the rotation direction of the rotation axis included in the arbitrary axis configuration selected by the selection unit.

9. The apparatus according to claim 8, wherein
the arbitrary translation axis is the translation axis to be actually used to machine the workpiece, and the arbitrary rotation axis is the rotation axis to be actually used to machine the workpiece,
the apparatus further comprises a storage unit that stores used axis configuration determination information for determining a used axis configuration having the translation axis to be actually used to machine the workpiece and the rotation axis to be actually used to machine the workpiece,
the selection unit determines, based on the used axis configuration determination information stored in the storage unit, whether or not there is the used axis configuration in axis configurations which have the translation axis included in the two or more translation axes and the rotation axis included in the at least one rotation axis, and selects the determined used axis configuration as the arbitrary axis configuration,
the translation axis correction value calculation unit calculates the correction value for the translation axis based on the homogeneous coordinate transformation of the error in the position of the tool from the workpiece coordinate system to the command value coordinate system of the translation axis included in the used axis configuration selected by the selection unit, and
the rotation axis correction value calculation unit calculates the correction value for the rotation axis based on the geometric error in the rotation direction of the rotation axis included in the used axis configuration selected by the selection unit.

10. The apparatus according to claim 9, further comprising:
an error decision unit that decides that the error in the position of the tool is to retain a previous error or to be set to zero if it is determined that there is the axis configuration that is not to be actually used to machine the workpiece in the axis configurations.

11. The apparatus according to claim 9, wherein
priority determination information for determining priority of use of each of the used axis configurations is stored in the storage unit, and
the apparatus further comprises:
a translation axis correction value decision unit that, if there are a plurality of the used axis configurations determined by the selection unit, decides that the correction value for the translation axis included in the used axis configuration determined to have highest priority of use based on the priority determination information stored in the storage unit is the correction value to be added to the translation axis command value by the update unit, the correction value being obtained from the correction values calculated for each translation axis included in each of the plurality of the used axis configurations by the translation axis correction value calculation unit; and
a rotation axis correction value decision unit that, if there are a plurality of the used axis configurations determined by the selection unit, decides that the correction value for the rotation axis included in the used axis configuration determined to have highest priority of use based on the priority determination information is the correction value to be added to the rotation axis command value by the update unit, the correction value being obtained from the correction values calculated for each rotation axis included in each of the plurality of the used axis configurations by the rotation axis correction value calculation unit.

12. The apparatus according to claim 10, wherein
priority determination information for determining priority of use of each of the used axis configurations is stored in the storage unit, and
the apparatus further comprises:
a translation axis correction value decision unit that, if there are a plurality of the used axis configurations determined by the selection unit, decides that the correction value for the translation axis included in the used axis configuration determined to have highest priority of use based on the priority determination information stored in the storage unit is the correction value to be added to the translation axis command value by the update unit, the correction value being obtained from the correction values calculated for each translation axis included in each of the plurality of the used axis configurations by the translation axis correction value calculation unit; and
a rotation axis correction value decision unit that, if there are a plurality of the used axis configurations determined by the selection unit, decides that the correction value for the rotation axis included in the used axis configuration determined to have highest priority of use based on the priority determination information is the correction value to be added to the rotation axis command value by the update unit, the correction value being obtained from the correction values calculated for each rotation axis included in each of the plurality of the used axis configurations by the rotation axis correction value calculation unit.
